(19) United States
(12) Patent Application Publication
(10) Pub. No.: US 2007/0083830 A1
(43) Pub. Date: Apr. 12, 2007

(54) Various methods and apparatuses for an executable parameterized timing model

(76) Inventors: Stephen Hamilton, Pembroke Pines, FL (US); Ian Andrew Swarbrick, Sunnyvale, CA (US); Scott Carlton Evans, Santa Clara, CA (US); Wolf-Dietrich Weber, San Jose, CA (US); Jay S. Tomlinson, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/246,809

(22) Filed: Oct. 7, 2005

(51) Int. Cl. G06F 17/50; G06F 9/45

(52) U.S. Cl. 716/1; 716/6; 716/4; 716/18

(57) ABSTRACT

Methods and apparatuses are described for an Intellectual Property (IP) Generator for estimating timing, area and power constraints in an electronic design system. The IP Generator receives a user-supplied file having data describing a configuration of an intellectual property (IP) design, the data includes one or more configuration parameters. The IP Generator further enables a transformation of the user-supplied file into a register transfer level design description. Next, the IP Generator receives user-supplied technology parameters and data-flow information. The technology parameters describe a configuration of the IP design. Next, the IP Generator executes a timing module based on the configuration of the IP design as well as executes a timing model for each hierarchical level in the IP design. The timing model predicts timing paths of a final logic circuit. Further, a result of the timing model is provided to the user prior to enabling a transformation of a register transfer level design into the simulation of a gate-level circuit design. Lastly, after the timing model has been executed, is the enablement of the transformation of the register transfer level design into the simulation of the gate-level circuit design.

### FIELD OF THE INVENTION

Aspects of embodiments described herein apply to the development process of electronic systems, especially Systems on a Chip (SOC).

### BACKGROUND

In computer networks, internetworking, communications, integrated circuits, etc., where there is a need to communicate information, there may be interconnections established to facilitate the transfer of the information. Interconnects may provide the physical communication network between two agents such as agents of Intellectual Property (IP) blocks. When designing systems that comprise such IP blocks and interconnects, the physical layout of IP blocks and its corresponding interconnects typically occur after the design/architecture and simulation stages are complete. Such an approach can potentially require revisions to the original design and simulation stages if it is not physically possible to place the components in such a way as to properly represent the original design. For example, a System on a Chip design may require the placement of components in such a way that is not physically possible to connect the various IP blocks in the manner when the architectural design was generated for this System on a Chip. Thus, one design hierarchy description may be used during the front-end design process and then possibly manually re-organized into a different design hierarchy description for use in the back-end design process. Under the traditional approach, such a problem may not be noticed until after the design and simulation stages have completed. The design would then have to be revised as well as further simulation testing. This approach could drastically increase the overall timeline of a development project. Another approach may be needed, where the physical layout of components may be incorporated into the architectural design stage. Such an approach may catch potential design problems earlier on, such that revisions to the original design, additional simulation and regeneration of Netlists are avoided.

### SUMMARY OF THE INVENTION

Methods and apparatuses are described for an Intellectual Property (IP) Generator for estimating timing, area and power constraints in an electronic design system. The IP Generator receives a user-supplied file having data describing a configuration of an intellectual property (IP) design, the data includes one or more configuration parameters. The IP Generator further enables a transformation of the user-supplied file into a register transfer level design description. Next, the IP Generator receives user-supplied technology parameters and data-flow information. The technology parameters describe a configuration of the IP design. Next, the IP Generator executes a timing module based on the configuration of the IP design as well as executes a timing model for each hierarchical level in the IP design. The timing model predicts timing paths of a final logic circuit. Further, a result of the timing model is provided to the user prior to enabling a transformation of a register transfer level design into the simulation of a gate-level circuit design. Lastly, after the timing model has been executed, is the enablement of the transformation of the register transfer level design into the simulation of the gate-level circuit design.

### BRIEF DESCRIPTION OF THE DRAWINGS

The present invention is illustrated by way of example and not limitation in the figures of the accompanying drawings, in which like references indicate similar elements and in which:

FIG. 1 illustrates an embodiment of a prior art method of a design flow for a system on a chip design.

FIG. 2 illustrates an embodiment for an improved design flow for an SOC design.

FIG. 3A illustrates an embodiment of a system architecture of an SOC compiler and Timing, Area and Power (TAP) modules.

FIG. 3B illustrates an embodiment of a method for estimating timing constraints in an electronic design system.

FIG. 3C illustrates an embodiment of a method of estimating area and power constraints for each hierarchical level within an IP design.

FIG. 4 illustrates an embodiment of a flow design of a timing module used as part of an SOC Compiler.

FIG. 5 illustrates an embodiment of a flow design of an area and power module used as part of an SOC Compiler.

FIG. 6 illustrates a graphical user interface (GUI) view of an embodiment of the integration of a set top box SOC design.

### DETAILED DESCRIPTION

In the following description, numerous specific details are set forth, such as examples of specific protocol commands, named components, connections, types of burst capabilities, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

In a highly configurable System on a Chip (SOC) interconnect, many configuration options enable a user to make trade-offs between Timing (latency and frequency), Area (logic gate/transistor and wire routing), and Power (dynamic and static) characteristics. It is therefore valuable to have a mechanism for enabling the user to estimate the impact of their configuration decisions on the Timing, Area and Power (TAP) characteristics of the finished SOC interconnect. Some traditional methods for TAP estimation require detailed physical implementation work, including synthesis, place and route, extraction and back-annotation, and application scenario-dependent power analysis. Such traditional methods prevent accurate TAP modeling during the architectural design stage since TAP estimates are not available until substantial physical implementation of the design has been established. This requires much time and cost, especially when numerous physical renditions may be required to accomplish acceptable TAP values for a given SOC interconnect.

A traditional design flow of an SOC interconnect design may begin with taking a register transfer level (RTL) description of a logic design and feeding it into a logic synthesis tool. Generally, an RTL description describes what intermediate information (i.e. information stored between clock cycles in a digital circuit) is stored in registers, where it is stored within the design, and how that information moves through the design as it operates. Generally, a logic synthesis tool transforms an SOC interconnect description from one level of abstraction to a lower level, usually towards some physical implementation. In one embodiment, logic synthesis translates an RTL design into a gate-level design. Traditionally, once an SOC interconnect design has been synthesized to a gate-level design, analysis may be done for TAP characteristics. It would be beneficial to have a method where such TAP estimates may be accomplished before an SOC interconnect is reduced to a gate-level design through logic synthesis. Such a method may drastically reduce the time and cost spent on such a design.

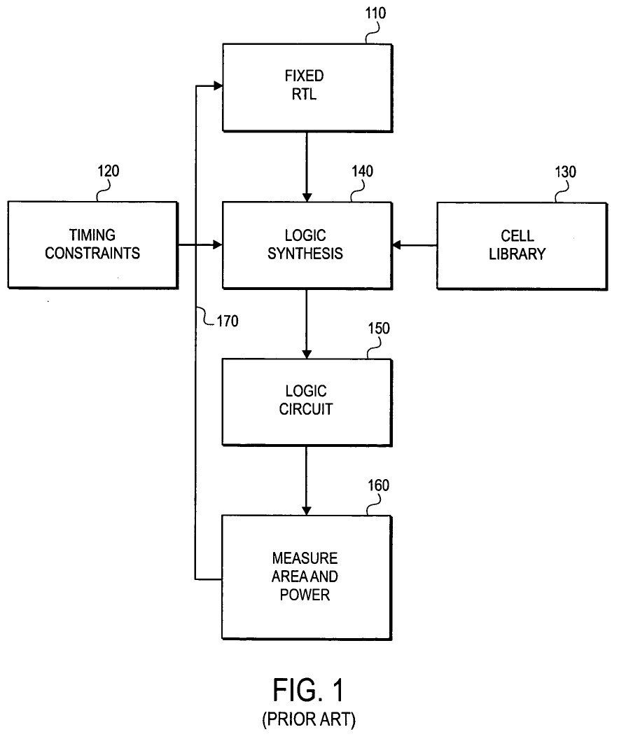

FIG. 1 illustrates an embodiment of a first way of design flow for an SOC design. A configured IP design, in the form of a fixed RTL 110 exists. Logic synthesis tool 140 receives the fixed RTL 110, as well as user-defined timing constraints 120 and a cell library 130. Logic Synthesis tool 140 synthesizes and outputs logic circuit 150 as a completed gate-level design circuit. Lastly, timing, area and power consumption measurements are taken 160 based on logic circuit 150. If timing, area and power measurements are not sufficient, the process starts over 170 by altering Fixed RTL 110 and moving through each step in FIG. 1 until acceptable TAP measurements are met by the user.

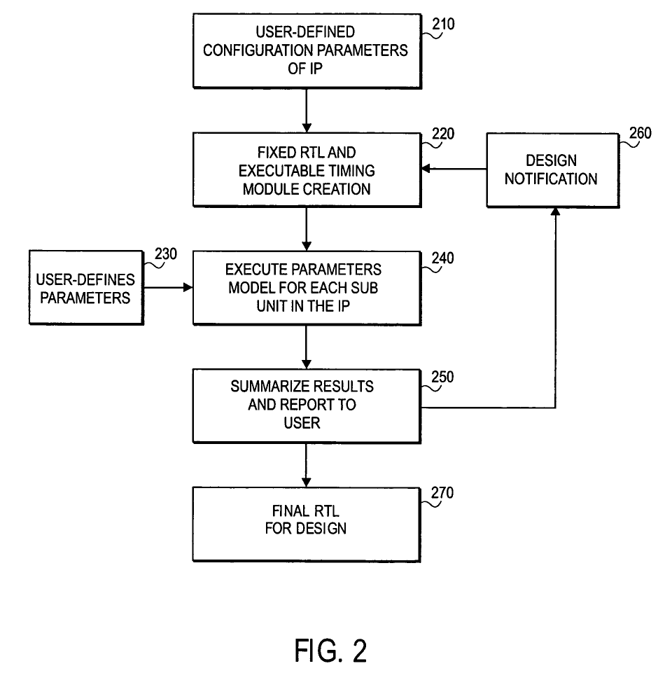

FIG. 2 illustrates an embodiment for an improved design flow for an SOC design. A method is described for capturing relevant TAP parameters as part of the original interconnect (pre-configuration) design. As a user considers an interconnect configuration, an analysis tool combines the user-defined TAP parameters with the configuration information. In one embodiment, the analysis tool would be a sub-level tool of a larger SOC compilation tool (SOCCOMP) or an IP Generation tool. Further, the analysis tool combines additional information about physical distances and various application scenarios to provide useful overall TAP information before any detailed physical implementation is performed (e.g. logic synthesis). In one embodiment, an external cell library is not required to process TAP estimates nor is the cell library required during logic synthesis.

In the first step, the user supplies a file that describes the configuration of an IP design(s) using a set of pre-defined parameters 210. Thus, the user creates an RTL design file with configuration parameters of the IP.

In the second step, the analysis tool translates the file into a register-level design description 220. Hence, the tool generates IP sub components of an electronic system design as an executable behavioral model. In one embodiment, the tool receives the user design and generates a configured IP design based on parameters in the received configuration file. In another embodiment, the register-level description of a digital electronic circuit is an intermediate level of an electronic design system between the functional description (e.g., register-level design) of the system and an actual physical layout of the electronic design system (e.g., gate-level design). Registers store intermediate information between clock cycles in a digital circuit, so an RTL description describes what intermediate information is stored, where it is stored within the design, and how that information moves through the design as it operates.

Next, user-specified technology parameters and data-flow information for timing, area and power consumption estimates are received 230. The user provides information that describes the important parameters of the silicon process technology. Thus, the user provides parameters describing the desired configuration of the IP design based on TAP values.

Next, for each sub-unit in the IP design, separate TAP models are executed 240. The analysis tool executes separate TAP models and reports the results to the user. In one embodiment, the separate timing, area and power modules are sub-modules of the larger analysis tool. Each model takes in user supplied technology parameters from step 230 and the configuration parameters derived from the RTL design file 210. Thus, for each design sub-unit in the IP, a parameterized model is executed which produces data on the timing, area and power of the unit. The TAP models may be built into the software that generates the IP sub-components as executable models. These models are used very early in the design flow to make trade-offs in the design parameters. These models are highly configurable. Execution of the models produces predictions of the timing, area and power consumption of the final logic circuit.

Next, the results of the executable TAP models are reported to the user 250. If the results are acceptable to the user, the design is finalized and is ready to be passed into the next design flow stage (e.g., logic synthesis).

If the performance results are not acceptable, or the user wants to continue making trade-offs, the design is modified 260 (by modifying the RTL design file) and steps 220-250 are repeated. Thus, the RTL design file may be continuously modified and steps 220-250 reprocessed until an acceptable TAP model is constructed.

Once the TAP models are accepted by the user, the logic synthesis tool translates the RTL into a gate-level circuit 270. Once a gate-level circuit exists, actual TAP measurements may be reported. Thus, the actual TAP characteristics which result after step 270 should be substantially similar to the TAP estimates compiled in step 250.

The advantages of the design flow illustrated in FIG. 2 over FIG. 1 should be obvious. The information of timing, area and power is available much earlier in the design flow from FIG. 2, than with FIG. 1. The TAP information may be generated much faster, since the TAP models are more abstract than those generated using logic synthesis. These TAP models may be used much earlier in the design flow to make trade-offs in the design parameters. This differs from the approach in FIG. 1, where TAP measurements of the design cannot be made until later in the design flow (e.g., after logic synthesis has been performed). Thus, the approach in FIG. 2 has a shorter modify/test loop than the approach in FIG. 1 by allowing a larger number of design parameters to be considered and optimized in a shorter period of time.

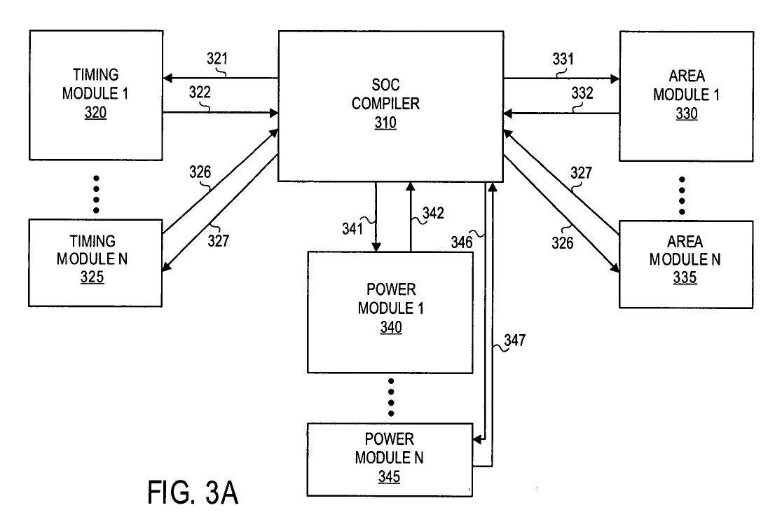

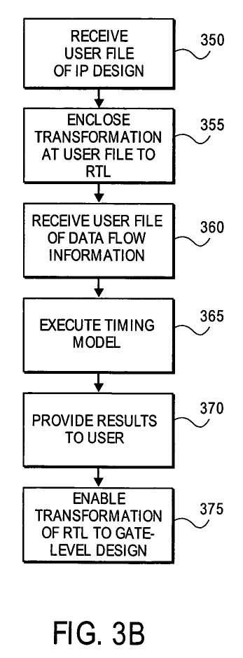

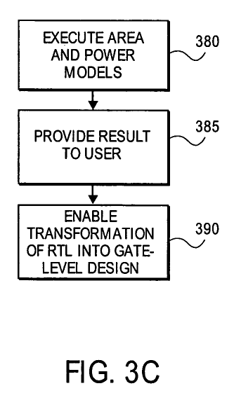

FIG. 3A illustrates an embodiment of a system architecture of an SOC compiler and TAP modules. In one embodiment, SOC Compiler 310 (SOCCOMP) is a compiler tool coupled to one or more TAP modules. SOCCOMP 310 is responsible for passing data structures to each TAP module, along with user-defined parameters and internally derived parameters. The data structures are empty database fields that will eventually be populated by the TAP modules. The user-defined parameters are constraints, defined by the user, that are used to configure the IP. The internally derived parameters are derived from within SOCCOMP 310 and are based on the user-defined parameters. These parameters are used to specifically configure sub-units in the RTL generation.

SOCCOMP 310 passes empty data structures, user-defined and internally derived parameters 321 to Timing Module 1 320. Timing Module 1 320 is a first instance of a timing module based on the first sub-unit within the RTL design. For each sub-unit within the RTL design a new instance of a timing module will be created. So there will be N timing modules 325 for N sub-units in the RTL design. Based on the received parameters and data structures, Timing Module 1 320 processes the information and populates the data structures. Timing Module 1 320 passes the populated data structures 322 back to SOCCOMP 310. SOCCOMP uses the received data structures to generate the actual timing estimates. Generation of the timing estimates are accomplished by determining the time frame to travel through each input and output of each IP sub component and aggregating the times for each IP sub component. In another embodiment, the timing module estimates a time frame to travel through each sub component in the electronic design system prior to processing the post logic synthesis estimates of the electronics system design. In another embodiment timing estimates are generated by determining the longest time frame to travel through each IP sub component. In another embodiment, the estimation of travel times are determined independent of using an actual circuit in a cell library. For each N timing module instance, empty data structures and parameters are passed 327 to Timing Module N 325, In turn, Timing Module N 325 returns. the populated data structures 326 to SOCCOMP 310.

Next, SOCCOMP 310 passes data structures, user-defined and internally derived parameters 331 to Area Module 1 330. Area Module 1 330 is a first instance of an area module based on the first sub-unit within the RTL design. For each sub-unit within the RTL design a new instance of an area module will be created. So there will be N area modules 335 for N sub-units in the RTL design. Based on the received parameters and data structures, Area Module 1 330 processes the information and populates the data structures. Area Module 1 330 passes the populated data structures 332 back to SOCCOMP 310. SOCCOMP uses the received data structures to generate the actual area estimates by aggregating the area estimates of all the IP sub components. In another embodiment, SOCCOMP 310 aggregates area estimates of all the IP sub components in the electronic system design prior to calculating the post logic synthesis estimate of the electronic system design. In another embodiment, the aggregation of the area estimates of all the IP sub components are done independent of using a design of an actual circuit in a cell library. For each remaining N area module instance, empty data structures and parameters are passed 336 to Timing Module N 335, with populated data structures returned 337 to SOCCOMP 310.

Next, SOCCOMP 310 passes data structures, user-defined and internally derived parameters 341 to Power Module 1 340. Power Module 1 340 is a first instance of a power module based on the first sub-unit within the RTL design. For each sub-unit within the RTL design a new instance of a power module will be created. So there will be N power modules 345 for N sub-units in the RTL design. Based on the received parameters and data structures, Power Module 1 340 processes the information and populates the data structures. Power Module 1 340 passes the populated data structures 342 back to SOCCOMP 310. SOCCOMP uses the received data structures to generate the actual power estimates by aggregating the power consumption estimates for all the IP sub components. In another embodiment SOCCOMP 310 aggregates the power consumption estimates of all the IP sub components in the electronics system design prior to calculating the post logic synthesis estimates of the electronic design. For each N power module instance, empty data structures and parameters are passed 346 to Power Module N 345, with populated data structures returned 347 to SOCCOMP 310.

In another embodiment, SOCCOMP 310 also contains a module to perform the post logic synthesis estimates of the electronic system design. These estimates enable a transformation of a circuit description from an abstraction layer to a physical implementation layer.

FIG. 3B illustrates an embodiment of a method for estimating timing constraints in an electronic design system. In general, a method for estimating timing, area and power constraints in an electronic design system is described. First, a user-supplied file having data describing a configuration of an IP design is received 350. In one embodiment, the data may include one or more configuration parameters. Next, a transformation of the user-supplied file into a register transfer level design description is enabled 355. Such a transformation may take place by an external module. Further, user-supplied technology parameters and data-flow information are received 360. In one embodiment, the technology parameters may describe the desired configuration of the IP design. In one embodiment a timing model is executed based on the configuration of the IP design.

In another embodiment, a timing model is executed 365 for each hierarchical level of the IP design. Hence, if the IP design contains 4 levels of hierarchy, the timing model is executed 4 times. For each level of hierarchy, the timing model predicts timing paths of the final logic circuit to be later implemented in a gate level design. The results of the timing model are provided to the user 370 prior to enabling the transformation of the register transfer level design into a simulation of gate-level circuit design. After the execution of the timing model, the transformation of the register transfer level design into a simulation of the gate-level circuit design is enabled 375. As stated above, the transformation of the RTL design into a simulation of a gate-level circuit design may be accomplished by an external module.

It is possible for a design to comprise multiple levels of hierarchy. In such a case, the models may be executed hierarchically. A multi-level hierarchy is made up of multiple modules. Each module can exist within other modules. As an example, module A may contain an instance of module B. Area and power models may be calculated for all parts of module A that exist within that level of hierarchy. Module B may be at one level lower in the hierarchy than A. The area and power models may be calculated for each instance of module B. In another embodiment, Module B may also contain additional modules. However, in this example each module has its area and power models sequentially calculated until all levels of the hierarchy are done. This means that all modules in level A may be calculated before moving on to level B. Once all the models from each level of hierarchy have been calculated, the totals are summarized. These totals may be reported as a single total, or may be broken into sub-totals for each level in the hierarchy.

FIG. 3C illustrates an embodiment of a method of estimating area and power constraints for each hierarchical level within an IP design. First, area and power models are executed for each hierarchical level in the IP design 380. These models predict area estimates and power consumption of a final logic circuit on a per level basis as well as a total of all levels of the circuit. Next, the user is provided a result of the area and power models 385. In one embodiment, these results are provided prior to enabling the transformation of the register-level design into a gate-level design. Lastly, transformation of the register transfer level design into the simulation of the gate-level circuit design is enabled 390. As stated above, this transformation may occur from an external module after the area and power models have been executed. In another embodiment, there may be execution a second timing, area and power model for each hierarchical level in the IP design based on a second set of revised parameters from the user prior to enabling the transformation of the register transfer level design into the simulation of the gate-level circuit design. Such execution may occur if the first results provided to the user were unacceptable, prompting changes to be made to the initial design.

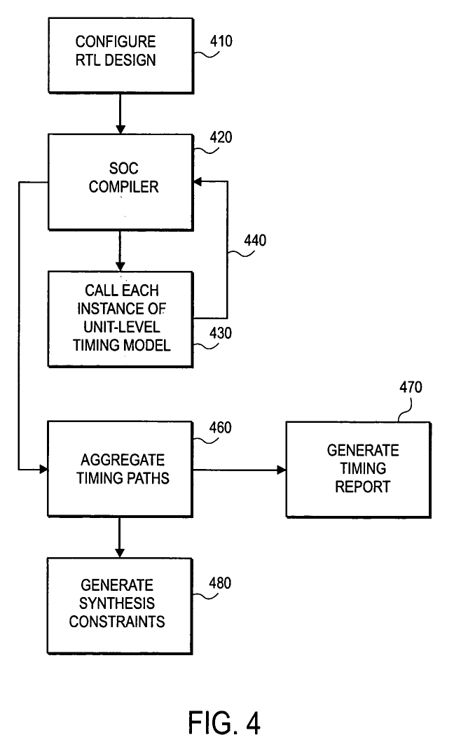

FIG. 4 illustrates an embodiment of a flow design of a timing module used as part of an SOC Compiler. The timing module is used to generate synthesis constraints and to report to the user the achievable clock frequency of their RTL design. First, the configuration of the RTL design 410 is passed to the SOC Compiler (SOCCOMP) 420. Once received, SOCCOMP 420 determines how many instances of the timing module will be required based on the number of sub-units in the RTL design. Next, SOCCOMP 420 calls each instance of the unit-level timing modules 430. SOCCOMP 420 sends empty data structures to each timing module instance along with user and internally derived parameters. Upon receipt of the data structures and parameters from SOCCOMP 420, each timing module populates the data structures and returns them 440 to SOCCOMP 420. Once all the populated data structures are received SOCCOMP 420 aggregates all the timing paths for each sub-unit in the RTL design 460. This information will give a total timing path for all sub-units in the design. Next, the timing data is reported 470 to the user as the achievable clock frequency of their RTL design. Lastly, SOCCOMP 420 uses the aggregated timing values to generate synthesis constraints 480 of the RTL design, which will be used during the logic synthesis which subsequently occurs.

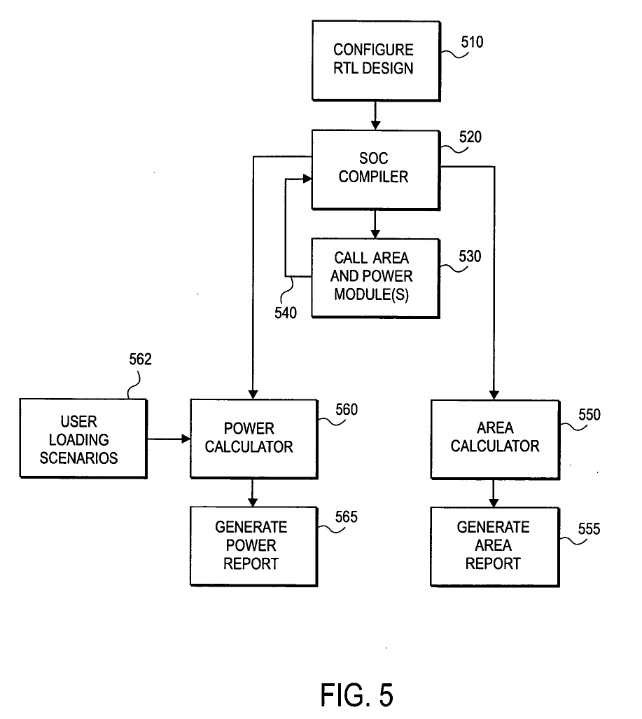

FIG. 5 illustrates an embodiment of a flow design of an area and power module used as part of an SOC Compiler. The area and power modules are used to report to the user the estimated total power consumption and area requirements of the RTL design. First, the configuration of the RTL design 510 is passed to the SOC Compiler (SOCCOMP) 520. Once received, SOCCOMP 520 determines how many instances of power and area modules will be required based on the number of sub-units in the RTL design. Next, SOCCOMP 520 sends empty data structures to each power and area module along with user and internally derived parameters. Upon receipt of the data structures and parameters from SOCCOMP 520, each power and area module populates the data structures and returns 540 the modules to SOCCOMP 520. Once all the populated data structures are received, SOCCOMP 520 receives user loading scenarios (data flows) 562 and calculates the total power consumed by the RTL design 560. Next, SOCCOMP 520 generates power reports 565 which are given to the user. Lastly SCCOMP 520 calculates the total area required by the RTL design 550 and generates area reports 555 which are given to the user.

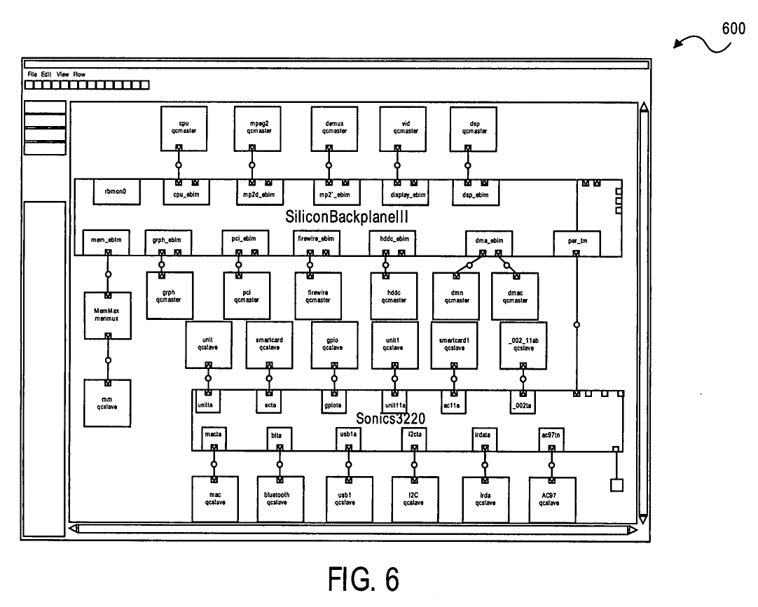

FIG. 6 illustrates a graphical user interface (GUI) view of an embodiment of the integration of a set top box SOC design. The example set top box SOC design 600 has multiple IP cores with two interconnect IP blocks all in a single System on a Chip. The groups of interconnect components from the two separate IP block representations of interconnects are combined during the front-end view design process by using the same design hierarchy description during the front-end view design process and the back-end file design process.

The example System on a Chip may have multiple IP cores such as a CPU core, a MPEG encoder/decoder core, a memory core, a Digital Signal Processor core, a Universal Service Bus core, a blue tooth core, a first interconnect IP core facilitating communications between a first set of IP cores, and a second interconnect IP core facilitating communications between a second set of IP cores as well as communications between the two IP interconnect cores.

In one embodiment, the software used to facilitate aspects of SOC design process can be embodied onto a machine-readable medium. A machine-readable medium includes any mechanism that provides (e.g., stores and/or transmits) information in a form readable by a machine (e.g., a computer). For example, a machine-readable medium includes read merely memory (ROM); random access memory (RAM); magnetic disk storage media; optical storage media; flash memory devices; DVD's, electrical, optical, acoustical or other form of propagated signals (e.g., carrier waves, infrared signals, digital signals, EPROMs, EEPROMs, FLASH, magnetic or optical cards, or any type of media suitable for storing electronic instructions. The information representing the apparatuses and/or methods stored on the machine-readable medium may be used in the process of creating the apparatuses and/or methods described herein. For example, the information representing the apparatuses and/or methods may be contained in an Instance, soft instructions in an IP generator, or similar machine-readable medium storing this information.

The IP generator may be used for making highly configurable, scalable System On a Chip inter-block communication systems that integrally manages data, control, debug and test flows, as well as other applications. In an embodiment, an example intellectual property generator may comprise the following: a graphic user interface; a common set of processing elements; and a library of files containing design elements such as circuits, control logic, and cell arrays that define the intellectual property generator. In an embodiment, a designer chooses the specifics of the interconnect configuration to produce a set of files defining the requested interconnect instance. An interconnect instance may include front-end views and back-end files. The front-end views support documentation, simulation, debugging, and testing. The back-end files, such as a layout, physical LEF, etc are for layout and fabrication.

What is claimed is:

1. An Intellectual Property (IP) generator, comprising:
a first module to generate IP sub components of an electronic system design as an executable behavioral model;
a timing module to estimate a time frame to travel through each IP sub-component in the electronic design system prior to processing the post logic synthesis estimates of the electronic system design; and
a second module to perform post logic synthesis estimates of the electronic system design.

2. The IP Generator of claim 1, wherein the timing module further estimates a time frame to travel through each individual input and output of each IP sub component.

3. The IP generator of claim 1, further comprising:
a power module to aggregate power consumption estimates of all the IP sub components in the electronic design system prior to calculating the post logic synthesis estimates of the electronic design.

4. The IP generator of claim 1, further comprising:
an area module to aggregate area estimates of all the IP sub components in the electronic design system prior to calculating the post logic synthesis estimate of the electronic design system.

5. The IP generator of claim 1, wherein the timing module further estimates a longest time frame travel path through each IP sub component of the electronic design system prior to the post logic synthesis estimates of the electronic design system.

6. The IP generator of claim 1, wherein estimating travel times through each IP sub component are independent of using a design of an actual circuit in a cell library.

7. The IP generator of claim 1, wherein the second module to perform post logic synthesis estimates of the electronic system design enables a transformation of a circuit description from an abstraction layer to a physical implementation layer.

8. An Intellectual Property generator, comprising:
a first module to generate IP sub components of an electronic system design as an executable behavioral model;
an area module to aggregate area estimates of all the IP sub components in the electronic design system prior to calculating the post logic synthesis estimate of the electronic design system; and
a second module to perform post logic synthesis estimates of the electronic system design.

9. The IP generator of claim 8, wherein aggregating area estimates of all the IP sub components are independent of using a design of an actual circuit in a cell library.

10. The IP generator of claim 8, wherein the second module to perform post logic synthesis estimates of the electronic system design enables a transformation of a circuit description from an abstraction layer to a physical implementation layer.

11. A method for estimating timing, area and power constraints in an electronic design system, comprising:
receiving a user-supplied file having data describing a configuration of an intellectual property (IP) design, the data to include one or more configuration parameters;
enabling a transformation of the user-supplied file into a register transfer level design description;
receiving user-supplied technology parameters and data-flow information, the technology parameters to describe a configuration of the IP design, and executing a timing module based on the configuration of the IP design;
executing a timing model for each hierarchical level in the IP design, the timing model to predict timing paths of a final logic circuit;
providing a result of the timing model to the user prior to enabling a transformation of a register transfer level design into a simulation of a gate-level circuit design; and
enabling a transformation of the register transfer level design into the simulation of the gate-level circuit design after execution of the timing model.

12. The method of claim 11, further comprising:
executing area and power models for each hierarchical level in the IP design, the models to predict area estimates and power consumption of a final logic circuit;
providing a result of the area and power models to the user prior to enabling the transformation of the register transfer level design into the simulation of the gate-level circuit design; and
enabling the transformation of the register transfer level design into the simulation of the gate-level circuit design after the execution of the area and power models.

13. The method of claim 11, further comprising:
executing a second timing, area and power model for each hierarchical level in the IP design based on a second set of revised parameters from the user prior to enabling the transformation of the register transfer level design into a simulation of a gate-level circuit design.

14. The method of claim 11, wherein predicting timing paths and area estimates are independent of using a design of an actual circuit in a cell library.

15. The method of claim 11, wherein the timing, area and power models are executed prior to processing post logic synthesis estimates of the IP design.

16. An apparatus generated by the method of claim 11.

17. A machine readable storage medium that contains instructions, which when executed by the machine cause the machine to perform the following operations, comprising:
receiving a user-supplied file having data describing a configuration of an intellectual property (IP) design, the data to include one or more configuration parameters;
enabling a transformation of the user-supplied file into a register transfer level design description;
receiving user-supplied technology parameters and data-flow information, the technology parameters to describe a configuration of the IP design, and executing a timing module based on the configuration of the IP design;
executing a timing model for each hierarchical level in the IP design, the timing model to predict timing paths of a final logic circuit;
providing a result of the timing model to the user prior to enabling a transformation of a register transfer level design into the simulation of a gate-level circuit design; and
enabling the transformation of the register transfer level design into the simulation of the gate-level circuit design after execution of the timing model.

18. The machine readable storage medium of claim 17 that contains instructions which cause the machine to perform the further operations, further comprising:
executing area and power models for each hierarchical level in the IP design, the models to predict area estimates and power consumption of a final logic circuit;
providing a result of the area and power models to the user prior to enabling the transformation of the register transfer level design into a simulation of gate-level circuit design; and
enabling the transformation of the register transfer level design into the simulation of the gate-level circuit design after the execution of the area and power models.

19. The machine readable storage medium of claim 17 that contains instructions which cause the machine to perform the further operations, further comprising:
executing a second timing, area and power model for each hierarchical level in the IP design based on a second set of revised parameters from the user prior to enabling the transformation of the register transfer level design into the simulation of a gate-level circuit design.

20. The machine readable storage medium of claim 17 that contains instructions which cause the machine to perform the further operations, wherein the predicting of the timing path constraints are independent of using a design of an actual circuit in a cell library.

21. The machine readable storage medium of claim 17 that contains instructions which cause the machine to perform the further operations, wherein the timing, area and power models are executed prior to processing post logic synthesis estimates of the IP design.

22. An apparatus generated by the instructions executed by the machine readable storage medium of claim 17.

23. An apparatus comprising:
means for receiving a user-supplied file having data describing a configuration of an intellectual property (IP) design, the data to include one or more configuration parameters;
means for enabling a transformation of the user-supplied file into a register transfer level design description;
means for receiving user-supplied technology parameters and data-flow information, the technology parameters to describe a configuration of the IP design, and executing a timing module based on the configuration of the IP design;
means for executing a timing model for each hierarchical level in the IP design, the timing model to predict timing paths of a final logic circuit;
means for providing a result of the timing model to the user prior to enabling a transformation of the register transfer level design into a simulation of a gate-level circuit design; and
means for enabling the transformation of the register transfer level design into a simulation of the gate-level circuit design after the execution of the timing model.

24. The apparatus of claim 23, further comprising:
means for executing area and power models for each hierarchical level in the IP design, the models to predict area estimates and power consumption of the final logic circuit;
means for providing a result of the area and power models to the user prior to enabling the transformation of the register transfer level design into the simulation of gate-level circuit design; and
means for enabling the transformation of the register transfer level design into the simulation of the gate-level circuit design after the execution of the area and power models.
